(19) United States
(12) Patent Application Publication
(10) Pub. No.: US 2016/0130448 A1
(43) Pub. Date: May 12, 2016

(54) COATING COMPOSITIONS COMPRISING CONDUCTIVE FILLERS

(71) Applicant: BASF SE, Ludwigshafen (DE)

(72) Inventors: Andreas EICHFELDER, Maxdorf (DE); Fabien Jean BRAND, Huningue (FR); Christian KRAUSCHE, Rudlingen (CH); Laszlo SZARVAS, Ludwigshafen (DE)

(73) Assignee: BASF SE, Ludwigshafen (DE)

(21) Appl. No.: 14/897,357

(22) PCT Filed: May 28, 2014
(86) PCT No.: PCT/EP2014/061058

§ 371 Date: Dec. 10, 2015

(30) Foreign Application Priority Data
Jun. 10, 2013 (EP) 13171239.0

(51) Int. Cl. C09D 5/24; D21H 21/14; C09J 9/02; C09D 7/12

(52) U.S. Cl. CPC C09D 5/24; C09D 7/1233; C09D 7/125; D21H 21/14; C09J 9/02

(57) ABSTRACT

A method for making a coating or sealing composition comprising incorporating organic filler(s) comprising at least 20 wt % of at least one organic polymer and at least one ionic liquid into a coating or sealing composition

The present invention relates to the use of organic fillers as additives for coating or sealing compositions where the organic fillers consist of at least 20 wt % of an organic polymer and comprise an ionic liquid.

A variety of liquid and solid adjuvants are known for the purpose of adjusting the electrical properties of coating or molding compositions which themselves conduct electrical current not at all or only to a very limited extent. Liquid additives may dissolve in the compositions and form conductive structures, such as thin aqueous layers at the interface with the ambient air, for example, which allow charge transport. Insoluble constituents may by mutual contact form a percolation pathway through which electrical charges can be transported.

Known adjuvants for adjustment of electrical properties include ionic liquids. Ionic liquids are salts having a melting point of not more than 150° C. WO 2007/115750 describes coating compositions which comprise ionic liquids and thus have antistatic properties. They are floor coatings with film thicknesses of 2 mm to 20 mm. With such thick coatings, generally speaking, conductive fillers such as graphite, carbon black, metal oxides, or fibers, such as carbon fibers, are additionally needed, and in the coating develop a conductive structure for diverting charges into the floor.

Liquid adjuvants can easily be exuded from the coating or molding compositions, meaning that the antistatic properties of the compositions deteriorate over time. In addition, liquid adjuvants may act simultaneously as plasticizer; a plasticizing effect, however, is frequently undesirable.

Where percolation is achieved, the use of solid adjuvants typically reduces the mechanical strengths. Moreover, the majority of conductive fillers are colored or, indeed, black; common conductive solids are, for example, carbon and metals or metal oxides in various modifications. This affects the diversity of colors that can be realized in the end product: when using solid adjuvants of these kinds, it is generally not possible for coating compositions to be transparent.

WO 2011/069960 discloses the use of polar, thermoplastic polymers containing ionic liquids as antistatic additives for nonpolar polymers such as polyolefins or polystyrene. The polar, thermoplastic polymers specified include polyurethanes and polyamides among others. Ionic liquids are mixed with the polar polymer by suitable methods. The antistaticized polymers obtained and the nonpolar polymers may then be used to product antistatic polymer blends by means of thermoplastic processing.

Object of the present invention were antistaticized coating compositions and antistatic coatings obtained from them that are easy to produce and have good antistatic properties. The antistatic properties are to be retained to as high a degree as possible for as long a time as possible. The performance properties of the coating compositions are as much as possible to remain unaffected. In addition, transparent antistaticized coatings are to be possible. Also an object of the invention in particular were coating compositions for floors that have the above properties and that do not require additional conductive fillers.

Found accordingly has been the use as defined at the outset. Also found have been coating compositions which comprise the organic fillers, and coatings produced from them. Additionally found in particular have been floorcoating compositions and floor coatings produced from them.

The organic fillers

The organic fillers are preferably fillers which are present as solids under standard conditions (20° C., 1 bar).

The organic fillers consist of at least 20 wt %, more particularly at least 50 wt %, and, in one particular embodiment, at least 70 wt % of an organic polymer.

Organic polymers contemplated are any polymers desired. They are preferably thermoplastically processable polymers, and more particularly they are thermoplastically processable polymers which possess sufficient hardness and can therefore readily be milled to form powders.

Preferred polymers are those having a Shore D value of greater than 50, more particularly greater than 70.

The Shore D value is a measure of the hardness of polymers. The Shore D value corresponds to the depth of penetration of a frustum having a circular point with a radius of 0.1 mm and an opening angle of 30° when the frustum is pressed onto the surface of the polymer with a force of 50 newtons.

Transparent polymers are preferred.

Particularly preferred are polar polymers, more particularly polyamides, polyurethanes, polyureas, or polyesters.

In one particular embodiment the organic polymer comprises polyamide or polyurethane, more particularly thermoplastic polyamide or thermoplastic polyurethane.

Preferred polyurethanes are those constructed to an extent of more than 60 wt %, more preferably more than 80 wt %, from diisocyanates and diols. Diisocyanates contemplated include aliphatic or aromatic diisocyanates. Aliphatic diisocyanates include more particularly C4 to C10 alkylene diisocyanates, more particularly hexamethylene diisocyanate, and cycloaliphatic diisocyanates, more particularly isophorone diisocyanate. Aromatic diisocyanates are understood here to mean those having at least one aromatic group, which may be substituted by alkyl groups or alkylene groups. Aromatic diisocyanates include more particularly diphenylmethane diisocyanate and tolylene diisocyanate. Mixtures of different diisocyanates are frequently used for preparing polyurethanes. Diols contemplated are short-chain diols, such as C2 to C10 alkylene diols, or long-chain diols, such polyether diols or polyester diols. Mixtures of different diols, especially combinations of short-chain and long-chain diols, are frequently used for preparing polyurethanes.

Besides diisocyanates and diols, the polyurethanes, for example, may in addition also be constructed from compounds having more than two isocyanate groups, such as isocyanurates, or having more than two hydroxyl groups, if a desired degree of branching is to be brought about. Compounds having only one isocyanate group or only one hydroxyl group serve to adjust the chain length and hence the molar weight.

Preferred polyamides are those constructed to an extent of more than 60 wt %, more particularly more than 80 wt %, from diamines, dicarboxylic acids, aminocarboxylic acids, and lactams. Polyamides are polycondensates available from diamines, such as aliphatic diamines, for instance C2 to C12 alkylenediamines, more particularly hexamethylenediamine, and dicarboxylic acids, such as aliphatic or aromatic dicarboxylic acids, for instance C2 to C16 alkylenedicarboxylic acids such as adipic acid, sebacic acid, azelaic acid, or dodecanedioic acid. Alternatively they are obtainable by intramolecular polycondensation of aminocarboxylic acids, such as aminoundecanoic acid, or lactams, such as caprolactam or laurolactam. The polyamides as well may consist of further structural components, examples being components aimed at setting a degree of branching or adjusting the molecular weight.

One particularly preferred polymer is polyamide 6 (polycondensation product of caprolactam), which is available for example as Ultramid B from BASF.

The organic fillers comprise an ionic liquid.

The ionic liquid heading covers salts (compounds composed of cations and anions) that under standard pressure (1 bar) possess a melting point of less than 150° C., preferably less than 100° C., more preferably less than 50° C. In one particular embodiment the salt in question is liquid at 20° C.

The ionic liquid heading is to be understood below to encompass not only individual liquids but also mixtures of different ionic liquids.

Preferred ionic liquids include an organic compound as cation (organic cation). Depending on the valence of the anion, the ionic liquid may comprise further cations, including metal cations, as well as the organic cation.

The cations of preferred ionic liquids are exclusively organic cations.

Suitable organic cations are, in particular, organic compounds having heteroatoms, such as nitrogen, sulfur, oxygen, or phosphorus; more particularly, the organic cations are compounds having an ammonium group (ammonium cations), an oxonium group (oxonium cations), a sulfonium group (sulfonium cations) or a phosphonium group (phosphonium cations).

In one particular embodiment, the organic cations of the ionic liquids are ammonium cations, which here include
nonaromatic compounds with a localized positive charge on a nitrogen atom having four substituents (quaternary ammonium compounds), or
compounds having a localized positive charge on a nitrogen atom having three substituents, with one bond being a double bond, or
aromatic compounds with a delocalized positive charge and with at least one, preferably one to three, nitrogen atom(s) in the aromatic ring system.

Preferred is a quaternary ammonium cation or a cation having a heterocyclic ring system with a delocalized positive charge or with a localized positive charge on one of the ring atoms.

Quaternary ammonium cations contemplated include for example those having three or four aliphatic substituents, examples being C1 to C12 alkyl groups, or C1 to C12 alkyl groups substituted by one or two hydroxyl groups; in the case of three aliphatic substituents, the fourth substituent is preferably a hydroxyl group.

As a cation with a heterocylic ring system, consideration is given to monocyclic, bicyclic, aromatic, or nonaromatic ring systems. Examples include bicyclic systems as described in WO 2008/043837. The bicyclic systems of WO 2008/043837 are diazabicyclo derivatives, preferably composed of a 7-membered ring and a 6-membered ring, and containing an amidinium group; one particular representative is the 1,8-diazabicyclo[5.4.0]undec-7-enium cation.

Especially preferred ionic liquids are those with cations comprising a heterocyclic ring system having one or two nitrogen atoms as part of the ring system.

Examples of organic cations of these kinds that are contemplated include pyridinium cations, pyridazinium cations, pyrimidinium cations, pyrazinium cations, imidazolium cations, pyrazolium cations, pyrazolinium cations, imidazolinium cations, thiazolium cations, triazolium cations, pyrrolidinium cations, and imidazolidinium cations. These cations are listed for example in WO 2005/113702. Where necessary for a positive charge on the nitrogen atom or in the aromatic ring system, the nitrogen atoms are each substituted by a hydrogen atom or by an organic group having generally not more than 20 C atoms, preferably a hydrocarbon group, more particularly a C1 to C16 alkyl group, more particularly a C1 to C10, very preferably a C1 to C4 alkyl group.

The carbon atoms in the ring system as well may be substituted by organic groups having generally not more than 20 C atoms, preferably a hydrocarbon group, more particularly a C1 to C16 alkyl group, more particularly a C1 to C10, very preferably a C1 to C4 alkyl group.

Particularly preferred ammonium cations are quaternary ammonium cations, imidazolium cations, pyrimidinium cations, and pyrazolium cations.

Particular preference attaches to imidazolium cations as present in formula I (see below).

The anions of the ionic liquids are, for example, anions from the groups listed below:

alkylsulfates RₐOSO₃⁻,

where Rₐ is a C1 to C12 alkyl group or a C5 to C12 aryl group, preferably a C1-C6 alkyl group or a C6 aryl group (tosylate);

alkylsulfonates

RₐSO₃⁻

where Rₐ is a C1 to C12 alkyl group, preferably a C1-C6 alkyl group,

halides, more particularly chloride, bromide, or iodide; and

pseudohalides, such as thiocyanate and dicyanamide (formula: N≡C—N—C≡N)

carboxylates R₂COO⁻;

where Rₐ is a C1 to C20 alkyl group or a C6 to C10 aryl or aralkyl group, preferably a C1-C8 alkyl group, more particularly acetate;

phosphates,

more particularly the dialkylphosphates of the formula RₐR_{b}PO₄⁻, where Rₐ and R_{b} independently of one another are a C1 to C6 alkyl group; more particularly Rₐ and R_{b} are the same alkyl group; representatives include dimethylphosphate and diethylphosphate;

and phosphonates, more particularly monoalkylphosphonic esters of the

formula RₐR_{b}PO₃⁻,

where Rₐ and R_{b} independently of one another are a C1 to C6 alkyl group.

Particularly preferred anions are methanesulfonate, trifluoromethanesulfonate, dimethylphosphate, diethylphosphate, methylsulfate, ethylsulfate, thiocyanate, and dicyanamide as anion in the ionic liquids.

Especially preferred are thiocyanate (SCN⁻) and dicyanamide.

With particular preference the solvent is an imidazolium salt of the formula I below

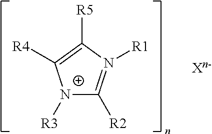

in which

R1 is an organic radical having 1 to 20 C atoms,

R2, R4, R3, and R5 are each an H atom or an organic radical having 1 to 20 C atoms,

X is an anion, and

n is 1, 2, or 3.

In formula I R1 and R3 are preferably, independently of one another, an organic radical having 1 to 10 C atoms. More particularly R1 and R3 are an aliphatic radical, more particularly an aliphatic radical without further heteroatoms, such as an alkyl group, for example. With particular preference R1 and R3 independently of one another are a C1 to C10 or a C1 to C4 alkyl group. Very preferably R1 and R3 independently of one another are a methyl group or an ethyl group.

In formula I R2, R4, and R5, preferably independently, are an H atom or an organic radical having 1 to 10 C atoms; more particularly R2, R4, and R5 are an H atom or an aliphatic radical. With particular preference R2, R4, and R5, independently of one another, are an H atom or an alkyl group; more particularly, R2, R4, and R5, independently of one another, are an H atom or a C1 to C4 alkyl group. Very preferably R2, R4, and R5 are each an H atom.

n is preferably 1.

X is preferably one of the abovementioned and preferred anions, very preferably thiocyanate and dicyanamide.

Examples of ionic liquids include, e.g.,

1-methyl-3-methylimidazolium thiocyanate,

1-methyl-3-ethylimidazolium thiocyanate,

1-methyl-3-methylimidazolium dicyanamide, and

1-methyl-3-ethylimidazolium dicyanamide.

For hydrophobic coating compositions or those comprising organic solvents, imidazolium salts having more carbon atoms in the substituents R1 to R5 may be advantageous on account of a better solubility. In one particular embodiment, therefore, for coating compositions of these kinds, imidazolium salts of the formula I are used in which the sum total of all the C atoms in substituents R1 to R5 is at least 6, preferably 6 to 20; the substituents may be H atoms and, for example, alkyl groups, as listed above. Alternatively or in addition it is also possible to use hydrophobic anions, examples being anions having a phenyl group, a heterocyclic group, or a long-chain alkyl group.

Stated on an exemplary basis may be imidazolium cations of the formula I with

R1=butyl, R3=butyl, R2=ethyl, R4=H, and R5=H (total number of C atoms in R1 to R5=10)

R1=ethyl, R3=methyl, R2=octyl, R4=H, and R5=H (total number of C atoms in R1 to R5=11).

A hydrophobic anion that may be mentioned in particular is phenylcarboxylate.

In paint and varnish applications, components with a low inherent color are frequently preferred (clear varnish, for example). The inherent color of the ionic liquids present in the organic fillers is therefore preferably very low. In one preferred form the ionic liquids have an iodine color number (in accordance with DIN 6162) of less than 20, more preferably less than 15, very preferably less than 10, more particularly less than 5, and, in one particular embodiment, less than 1.

The organic fillers comprise preferably at least 1 wt %, more preferably at least 3 wt %, very preferably at least 5 wt %, and, in one particular embodiment, at least 10 wt % of ionic liquid. Generally speaking, the amount of anionic liquid in the organic fillers is not higher than 40 wt %, more particularly not higher than 30 wt %. On account of the good antistatic effect, an amount of not more than 20 wt % of ionic liquid in the organic fillers is also sufficient.

The organic fillers may comprise further constituents as well as the organic polymer and the ionic liquid. Examples of those contemplated include stabilizers, driers, residual solvents from production operations, inorganic fillers, such as metal oxides, silicates, or metal sulfates, pigments, dyes, flame retardants, thickeners, thixotropic agents, surface-active agents, plasticizers, chelating agents, or other compounds with antistatic effect.

However, other compounds with antistatic effect, examples being carbon in any of its modifications, such as carbon black, graphite, or carbon fiber, for example, or else metal or metal oxides, are not needed for effective antistaticization, and are therefore used preferably, if at all, in minor amounts of less than 5 wt %, more particularly less than 1 wt %, based on the total weight of the organic fillers. With very particular preference no other antistatic additives are used in the organic fillers. Preferably, in particular, few or no antistatic additives are used that comprise metals. The organic fillers have a total metals content of preferably less than 3 wt %, more particularly less than 0.5 wt %, more preferably less than 0.1 wt %; the term “metals” encompasses metals in any form—that is, as element, as cation, or as part of complex compounds.

Examples of stabilizers contemplated include sterically hindered phenols, and secondary antioxidants such as phosphites, phosphonites, phosphonates, and thioethers.

The organic fillers may comprise stabilizers for example in an amount of 0.05 to 5, more preferably of 0.1 to 3 wt %.

For producing the organic fillers, the above constituents may be contacted in any order and mixed with one another. Accordingly, the ionic liquid and other constituents may be present already during the preparation of the organic polymer, or may not be added to the organic polymer until after its production, and may be mixed with the polymer by customary techniques.

The ionic liquid may be added to the polymer during, for example, a thermoplastic processing operation; in particular, the ionic liquid may be added during the extrusion of the polymer. The extrudate then contains the ionic liquid and can if desired be processed further—milled to a powder, for example.

The polymer is used preferably in the form of a powder. To that end the polymer or the mixture of polymer, ionic liquid, and, optionally, further constituents is milled. The powder preferably has a particle size distribution with a d₅₀ of 5 to 500 μm, more particularly 10 to 400 μm, and a d₉₀ of 10 to 700 μm, more particularly 20 to 500 μm.

For coating compositions which are applied in thin film thicknesses (dry, without solvent) of less than 1 mm, for example, particularly suitable powders are those with a d₅₀ of 5 to 50 μm, and/or a d₉₀ of 10 to 100 μm.

For coating compositions which are applied in thicker film thicknesses (dry, without solvent) of 1 mm to 30 mm, for example, particularly suitable powders are those with a d₅₀ of 50 to 400 μm, and/or a d₉₀ of 100 to 700 μm.

The d₅₀ of the particle size distribution indicates that 50 wt % of the particles have a diameter smaller than the stated diameter.

The d₉₀ of the particle size distribution indicates that 90 wt % of the particles have a diameter smaller than the stated diameter.

In one preferred embodiment the organic filler is obtained by milling the polymer to a powder and subsequently treating the powder with ionic liquid. Without ionic liquid present the polymer is harder and can therefore be milled more easily.

The polymer may optionally also be dried before the ionic liquid is added to it. Before the addition of the ionic liquid, the polymer powder preferably has a residual solvent (water or organic solvents) content of less than 5 wt %, more particularly less than 1 wt %, very preferably less than 0.2 wt %.

Ionic liquid is then added in the desired amount to the milled powder. The powder takes up the ionic liquid in sufficient quantities.

For these operations the polymer and ionic liquid may be contacted in mixing apparatus, such as in high-speed mixers, for example. The takeup of the ionic liquid by the polymer is supported by effective mixing and takes place quickly and completely.

The ionic liquid here may also be used in a mixture with solvents. The term “solvent” in this patent application refers to nonionic compounds which are liquid at 20° C. and which are removed no later than when the coating or sealing composition is used. Through accompanying use of solvents it is possible optionally to promote the takeup of the ionic liquid by the organic polymer, and the distribution of the ionic liquid in the organic polymer.

Possible solvents are, for example, water, alcohols, esters, ethers, ketones, aromatic solvents, alkoxylated alkyl alkanoates, carbonates, or mixtures of the solvents.

Alcohols here are hydrocarbon compounds having one to three hydroxyl groups and a molecular weight of less than 200 g/mol.

Esters are, for example, n-butyl acetate, ethyl acetate, 1-methoxyprop-2-yl acetate, and 2-methoxyethyl acetate.

Ethers are, for example, THF, dioxane, and the dimethyl, diethyl or di-n-butyl ethers of ethylene glycol, diethylene glycol, triethylene glycol, propylene glycol, dipropylene glycol, or tripropylene glycol.

Ketones are, for example, acetone, ethyl methyl ketone, diethyl ketone, isobutyl methyl ketone, methyl amyl ketone, and tert-butyl methyl ketone. Acetone is less preferred on account of its flash point.

Preferred aromatic hydrocarbons are more particularly xylene and toluene, especially xylene. Mixtures of aromatics are in principle also suitable, but are less preferred. Examples of such are the commercial Solvesso® brands from ExxonMobil Chemical, especially Solvesso® 100 (CAS No. 64742-95-6, predominantly C9 and C10 aromatics, boiling range about 154-178° C.), 150 (boiling range about 182-207° C.), and 200 (CAS No. 64742-94-5), and also the Shellsol® brands from Shell, Caromax® (e.g. Caromax® 18) from Petrochem Carless, and Hydrosol from DHC (e.g., as Hydrosol® A 170).

Other possible solvents are butyl glycol diacetate, butyl glycol acetate, dipropylene glycol dimethyl ether, 3-methoxy n-butyl acetate, dipropylene glycol n-butyl ether and propylene carbonate.

Particularly preferred solvents are alcohols, such as methanol, ethanol, isopropanol, acetonitrile, and mixtures thereof.

As solvents for the ionic liquids it is possible with preference to use those in which the respective ionic liquids used dissolve at 23° C. to an extent of more than 10 wt %, preferably more than 30 wt %.

The above accompanying use of solvent is unnecessary generally when using mixing apparatus as described above. It might, however, be useful if ionic liquid and polymer are contacted without mixing.

Where solvents are used, they can be separated from the powder, by heating, for example.

The solvent content of the powder is therefore preferably less than 5 wt %, more preferably less than 1 wt %, and very preferably less than 0.3 wt %.

In one preferred variant the ionic liquids are incorporated into the organic polymer without accompanying use of solvents; the powders comprising the ionic liquid are therefore preferably free from solvents.

The above-described organic fillers consist preferably in total of

20 to 99 wt % of the organic polymer

1 to 30 wt % of ionic liquid, and

0 to 40 wt % of further constituents

The organic fillers consist with particular preference of

60 to 95 wt % of the organic polymer

5 to 30 wt % of ionic liquid, and

0 to 20 wt % of further constituents

In one especially preferred embodiment the organic fillers consist of

60 to 90 wt % of the organic polymer

10 to 25 wt % of ionic liquid, and

0 to 10 wt % of further constituents

Use

The organic fillers are used as additives for coating or sealing compositions.

Coating or sealing compositions contemplated are those with any desired chemical composition that are intended for any desired utility.

The coating compositions may for example be adhesives, varnishes, paints, papercoating compositions, or floorcoating compositions.

Sealing compositions are generally likewise compositions having adhesive properties, but contain a high fraction of fillers such as calcium carbonate, titanium dioxide, and/or silicates, and so are introduced in high film thicknesses into joints, cracks, and gaps in order to seal them.

Adhesives contemplated include, for example, pressure-sensitive adhesives, contact adhesives, or construction adhesives. Adhesives of these kind are applied in the desired thicknesses, as coating material, to at least one of the shaped parts that are to be bonded, and are then bonded according to customary methods.

Other coating compositions such as paints, varnishes, papercoating compositions, or floorcoating compositions provide protection, for example, from mechanical stress and/or have decorative purposes. They are suitable for coating substrates such as wood, wood veneer, paper, paperboard, cardboard, textile, film, leather, nonwoven, plastics surfaces, glass, ceramic, mineral building materials, such as molded cement slabs and fiber-cement slabs, or metals, each of which may optionally have been already coated and/or pretreated. Coating compositions of these kinds are suitable as or in interior or exterior coatings, in other words those applications involving exposure to daylight, preferably on parts of buildings, coatings on (large) vehicles and aircraft, and industrial applications, utility vehicles in the agricultural and construction sectors, decorative finishes, bridges, buildings, power masts, tanks, containers, pipelines, power stations, chemical plants, ships, cranes, posts, sheet piling, valves, pipes, fittings, flanges, couplings, halls, roofs, and structural steel, furniture, windows, doors, wood flooring, can coating, and coil coating, for floor coverings, such as in stores, in industrial facilities, for parking levels, or in hospitals.

Besides the organic fillers, the coating or sealing compositions preferably comprise at least one binder and optionally further adjuvants usual for the particular utility.

The binders may be polymers obtainable for example by radical polymerization, by polycondensation or by other types of formation of polyadducts.

Mention may be made of polymers consisting to an extent of more than 50 wt %, more particularly more than 70 wt %, of (meth)acrylic monomers, e.g., C1-C10 alkyl(meth)acrylates (polyacrylates for short).

Mention may be made of polymers which consist to an extent of more than 50 wt %, more particularly more than 70 wt %, of vinyl esters, e.g., vinyl acetate (vinyl ester polymers for short).

Mention may be made of polymers which consist to an extent of more than 50 wt %, more particularly more than 70 wt %, of styrene, butadiene, or mixtures thereof (styrene-butadiene polymers for short).

Polyacrylates, vinyl ester polymers, and styrene butadiene polymers are prepared preferably by aqueous emulsion polymerization and are therefore preferably in the form of a dispersion in water.

Mention may also be made of polymers which consist to an extent of more than 50 wt %, more particularly more than 70 wt %, of diisocyanates and diols (polyurethanes for short).

Polyurethanes for coating use are frequently prepared by reacting the starting materials in water or organic solvents, and are therefore preferably in the form of an aqueous polyurethane dispersion or a solution of polyurethanes in an organic solvent.

Mention may be made of polycondensates which consist to an extent of more than 50 wt %, more particularly more than 70 wt %, of dicarboxylic acids and diols (polyesters for short).

Polyesters may be obtained, for example, by polycondensation in water or in an organic solvent, and are therefore preferably in the form of solutions.

Binders contemplated include oligomers or monomers which are preferably liquid at room temperature (20° C.) and do not require solvent; more particularly they are reactive binders, in which case a chemical reaction takes place after coating, or UV-curable binders, which are cured by exposure to UV light after coating has taken place.

Also frequently used for coatings are binder systems made up of two components; these systems comprise two different constituents which cure when used, and which are therefore referred to below as reactive binder systems.

Examples of reactive binder systems include epoxy compounds and hardeners, preferably amine hardeners, which cure to form epoxy resins.

Reactive binder systems include compounds having at least two isocyanate groups (diisocyanates) and compounds having at least two hydroxyl groups (diols), which cure to form polyurethanes.

Reactive binder systems also include compounds having at least two isocyanate groups (preferably diisocyanates) and compounds having at least two amino groups (preferably diamines), which cure to form polyureas.

UV-curable binders include, for example, (meth)acrylic monomers having more than one (meth)acrylic group, more particularly aliphatic compounds having 2 to 5 (meth)acrylic groups and a molecular weight of less than 300 g/mol (e.g., Laromers® from BASF) or low molecular mass polyesters which contain radiation-curable groups as a result, for example, of the accompanying use of maleic acid as dicarboxylic acid.

In the case of further adjuvants customary for the particular utility, the adjuvants in question are, in the case of the adhesives, for example, tackifying resins (tackifiers, examples being rosins); in the case of the sealing compositions, for example, fillers and/or pigments, examples being calcium carbonates, titanium dioxide, aluminum dioxide, silicon dioxide, and silicates; and in the case of paints, varnishes, or floor coatings, for example, dyes, pigments and/or fillers.

Further adjuvants for the above utilities are thickeners, flow control assistants, stabilizers, etc.

The coating or sealing compositions may be aqueous coating or sealing compositions or may be coating or sealing compositions comprising organic solvents; they may also be coating or sealing compositions which comprise little or no water or organic solvents, more particularly less than 5 wt %, more particularly less than 2 wt %, of water and organic solvents.

The latter coating or sealing compositions are, for example, those which comprise liquid binders (reactive or UV-curable binders; see above) or those from which water or organic solvents have already been removed and which are therefore present for example in powder form, examples being powder coatings.

The organic fillers are suitable as additives for coating or sealing compositions.

The organic fillers may be mixed in any desired way with the other constituents of the coating or sealing compositions.

The figures below for the amount of the organic fillers in the coating or sealing compositions, including in floorcoating compositions, are based on all of the constituents of the coating or sealing composition except for solvent. The term “solvent” refers in this patent application, as already stated above, to nonionic compounds which are liquid at 20° C. and which are removed no later than during the use of the coating or sealing composition, and which therefore do not become part of the resultant coating or seal. Solvents of this kind are water or nonionic, organic solvents.

The coating or sealing compositions contain preferably at least 0.1 wt %, more preferably at least 1 wt %, very preferably at least 5 wt %, and, in one particular embodiment, at least 10 wt % of the organic fillers.

The coating or sealing compositions comprise in general not more than 40 wt %, more particularly not more than 30 wt %, of the organic fillers, since a higher level is unnecessary for optimum antistatic properties.

The coating or sealing compositions can be processed in a customary way. The resulting coatings may have film thicknesses, for example, of 5 μm to 30 mm, preferably of 10 μm to 20 mm. With the sealants it is possible to seal or bridge, for example, cracks, gaps or joints with large or small dimensions.

One preferred embodiment of the invention uses the organic fillers as additives to floorcoating compositions.

The floorcoating compositions comprise preferably 5 to 40 wt %, more preferably 10 to 30 wt %, of the organic fillers, based on the total weight of all the constituents of the floorcoating compositions except for water and organic solvents.

The floorcoating compositions in question may be any of a very wide variety of such compositions based on the above binders, and in particular the binders of the floor coating compositions may be the reactive binder systems described above. The floor coatings obtained therewith may in particular also be transparent.

The floor coatings obtained preferably have a film thickness of 1 mm to 30 mm, more preferably of 2 mm to 20 mm, more preferably of 4 mm to 20 mm. With such floor coatings it has generally been necessary to date, in addition to antistatic additives such as ionic liquids, to have conductive fillers as well, such as graphite, carbon black, metal oxides, or fibers, such as carbon fibers, which construct a conductive structure within the coating. The conductive structure diverts charges into the floor.

An advantage of the present invention is that conductive fillers, such as carbon black, graphite, or carbon fiber, or metal or oxides of metal, are not needed for effective antistaticization, and are therefore present preferably at most in minor amounts of less than 5 wt %, more particularly less than 1 wt %, very preferably less than 0.2 wt %, based on the total weight of the coating or sealing composition (without solvents; see above); very preferably the coating or sealing compositions are free from such conductive fillers. The above observations apply in particular in respect of floor coating compositions, since here the organic powders take on the function of the conductive fillers and form a coherent structure to divert charges into the floor.

The coating or sealing compositions have very good antistatic properties. The good antistatic properties are retained over a long time. No decrease, or hardly any decrease, is observed in the antistatic properties over time. The performance properties of the coating and sealing compositions are impaired little if at all.

### EXAMPLES

Starting materials used:

Polyamide 6: Ultramid B27E (BASF SE)

Polyamide 12: Orgasol 2002 ES 5 NAT 3 (Arkema)

Basionics VS03: ethylmethylimidazolium dicyanamide (BASF SE)

Basionics FS 01: quaternary ammonium salt (BASF SE)

Basionics UV43: tripropylallylammonium dicyanamide (BASF SE)

Preparation of Organic Fillers

Preparation of an Organic Filler without Ionic Liquid

Fillers 1 and 2

The commercially available polyamide 6 pellets are comminuted using a serial mill combination of universal rotor mill and opposed jet mill. Classification takes place by screening. Oversize is returned and milled again. A dry, free-flowing powder is obtained (filler 1).

For the evaluation of a change to the polymer in the extruder, the polyamide 6 is run through an extruder without additions; the heating zones are 160-220° C. in six stages, and afterward milling takes place in the same way as for filler 1 (filler 2).

Addition of Ionic Liquid During Extrusion of Organic Polymer

(Method 1—Extrusion Charging)

Fillers 3 to 8

Polyamide 6 is introduced into a twin-screw extruder. The heating zones are 160-220° C. in six stages. After the first quarter, the ionic liquid is introduced via a separate feed. The molten discharge is cooled in a waterbath and chopped. Prior to milling, the polymer is dried to a water content <0.1%. The conductive pellets are subjected to multistage comminution in an air jet mill cooled with liquid nitrogen.

The residue is a dry, free-flowing powder.

Addition of Ionic Liquid to the Polymer Powder

(Method 2—Migration Charging)

Fillers 9 to 11

Ionic liquid and isopropanol are mixed at 23° C. and milled polyamide 6 (see above, filler 1) is added, and the mixture is heated to 60° C.

The ionic liquid is taken up by the polyamide 6 within 1 hour, with no incipient swelling of the polyamide powder. Lastly the solvent is removed by vacuum distillation in 30 minutes, to leave a dry, free-flowing powder.

The commercially available polyamide 12 is used in its supply form (filler 12).

Addition of Ionic Liquid to the Polymer Powder

(Method 2—Migration Charging)

Fillers 13 to 16

Ionic liquid and isopropanol are mixed at 23° C. and milled polyamidel2 (see above, filler 12) is added, and the mixture is heated to 60° C.

The ionic liquid is taken up by the polyamide 12 within 1 hour, with no incipient swelling of the polyamide powder. Lastly the solvent is removed by vacuum distillation in 30 minutes, to leave a dry, free-flowing powder.

Measurement Methods

The Shore hardness D is a measure of the hardness. The higher the figure reported for the Shore hardness, the greater the resistance of the material tested to the penetration of a measuring point.

The glass transition temperature was determined by DSC (differential scanning calorimetry).

The volume resistivity (ρ) in [Ωcm] is the electrical resistance measured between the underside of a floor covering and an individual electrode sited on the traffic surface, based on the thickness of the floor covering.

It is the measure of the diversion of charges through the overall film thickness of the coating. The lower the volume resistivity, the better the diversion of charges.

The surface resistivity [Ω] is the resistance between two points, measured between two electrodes sited on the traffic surface, based on the distance between the electrodes.

It is a measure of the diversion of charges on the surface of the coating. The lower the surface resistivity, the greater the ease with which charges flow off over the surface.

Resistance to earth in accordance with EN 1081 is the electrical resistance measured on a laid floor covering between the surface and the earth. The higher the figure, the poorer the diversion of electrical charges into the earth (ground).

BVG (body voltage generation) is a measure of the charge imparted to a person moving over the floor covering, and is measured in accordance with EN 1815. The BVG figure is preferably to be less than 100 volts (V).

The system resistance is the resistance to earth of the person/footwear/floor covering system, and is measured in accordance with EN 61340-4-5. The system resistance is preferably to be less than 35 megaohms.

Powder Properties

Figures for the composition and properties of the organic fillers, and the production method, are given in Table 1:

| | | Volume | | |
|---|---|---|---|---|
| | | resistivity (ρ) | | Shore D |
| | | [Ωcm] | Tg | hard- |
| | Production | (*) | [° C.] | ness |
| Filler 1 | Polyamide 6, as-supplied | 2.0E+12 | 39 | 92 |
| | condition, milling | | | |
| Filler 2 | Polyamide 6 extruded | 2.2E+12 | 37 | 92 |
| | without addition, | | | |
| | milling | | | |
| Filler 3 | Polyamide 6 + 5% | 3.6E+08 | 6 | 91 |
| | Basionics VS03 | | | |
| | extruded, milling | | | |
| Filler 4 | Polyamide 6 + 7% | 4.5E+06 | −13 | 88 |
| | Basionics VS03 | | | |
| | extruded, milling | | | |
| Filler 6 | Polyamide 6 + 10% | 1.3E+05 | −24 | 85 |
| | Basionics VS03 | | | |
| | extruded, milling | | | |
| Filler 7 | Polyamide 6 + 7% | 2.9E+09 | 15 | 91 |
| | Basionics UV43 | | | |
| | extruded, milling | | | |
| Filler 8 | Thermoplastic | 3.9E+07 | −80 | 36 |
| | polyurethane + | | | |
| | 10% Basionics VS 03 | | | |
| | extruded, milling | | | |
| Filler 9 | Filler 1 + 7% | | | |
| | Basionics VS 03 | | | |
| | migration charging | | | |
| Filler 10 | Filler 1 + 10% | | | |
| | Basionics VS | | | |
| | 03 migration charging | | | |
| Filler 11 | Filler 1 + 12% | | | |
| | Basionics VS | | | |
| | 03 migration charging | | | |
| Filler 12 | Polyamide 12 | | | |
| | without addition | | | |
| Filler 13 | Polyamid 12 + 7.5% | | | |
| | Basionics VS 03, | | | |
| | migration charging | | | |
| Filler 14 | Polyamide 12 + 10% | | | |
| | Basionics VS 03, | | | |
| | migration charging | | | |
| Filler 15 | Polyamide 12 + 15% | | | |
| | Basionics VS 03, | | | |
| | migration charging | | | |
| Filler 16 | Polyamide 12 + 7.5% | | | |
| | Basionics VS 03 + 7.5% | | | |
| | Basionics FS 01, | | | |
| | migration charging | | | |

Explanation: E stands for the exponential form, e.g., 2.0E+12 stands for 2.0×10¹²

Production and testing of the coating compositions

Coating Composition 1: 2K PU Solventborne

| | | |
|---|---|---|
| 53.6 g | Macrynal SM510N | polyacrylateol, Nuplex Resins, |
| | | Bergen, NL |
| 10.6 g | butylglycol acetate | |
| 4.4 g | Solvesso 100 | aromatic solvent, ExxonMobil Corp., |
| | | Machelen, B |
| 2.6 g | methyl isobutyl | |
| | ketone | |
| 0.07 g | Octa Soligen Zinc 8 | metal catalyst, Borchers GmbH, D |
| 0.13 g | BYK 300 | surface additive, BYK Chemie, Wesel, D |
| 28.6 g | Basonat HB 175 | isocyanate hardener, BASF SE, |
| | | Ludwigshafen, D |

Filler 6 was added to the above coating composition. The amount of organic filler added is based in each case on the resulting coating (without water or organic solvents, which evaporate in the course of drying). Filler 6 was readily miscible with the coating composition; any sediment occurring could easily be reagitated, even after prolonged storage of the coating compositions obtained.

This coating composition was produced by a customary technique and applied to a glass plate using a four-way bar applicator. Drying at 23° C. over a period of 3 weeks gives a dry varnish film with a dry film thickness of 150-250 μm.

TABLE 2
Coating composition 1

| | | | Sample |
|---|---|---|---|
| | Volume resistivity (ρ) | Surface resistivity | thickness |
| | [Ω cm] | (σ) [Ω] | [mm] |
| no organic filler | 8.9E+13 | 2.0E+13 | 0.15 |
| 8% filler 6 | | 6.5E+12 | 0.22 |
| 14% filler 6 | | 4.1E+12 | 0.21 |
| 22% filler 6 | 9.7E+10 | 2.5E+12 | 0.21 |
| 30% filler 6 | 2.1E+10 | 4.0E+10 | 0.24 |

Coating Composition 2: 100% Epoxy Industrial Floor Coating

Filler 11 was added to an epoxy binder for industrial coatings (based on bisphenol A, molar mass<700) comprising a monofunctional glycidyl ether as reactive diluent, inorganic fillers, and cycloaliphatic diamine as hardener, and the antistatic properties of the coating obtained were tested.

For this purpose, filler 11 was first mixed with the epoxy binder, the glycidyl ether, and the inorganic fillers, and then the hardener was added. The mixture was subsequently coated onto fiber-cement panel.

The floorcoating obtained had a film thickness of approximately 2 mm.

The amount of the filler of the invention in the floorcoating was 22 wt %.

For comparison, filler 11 was replaced by filler 1 (without ionic liquid charging) in the same amount.

As a supplement, a further comparative test was carried out, in which filler 11 was replaced by the same amount of filler 1 and additionally, separately, ionic liquid was added (2.5 wt % of Basionics VS 03/FS01 in a 50:50 weight ratio). The amount of 2.5 wt % of ionic liquid corresponded to the amount of ionic liquid in filler 11 (12% Basionics in filler 11×0.22=2.6).

TABLE 3
Results with coating composition 2

| Coating | | Body voltage | |
|---|---|---|---|
| compo- | | generation | System |
| sition 2 | Resistance to earth | (BVG) | resistance |
| with 22 wt % | 20-80 megaohms | less than | less than 100 |
| filler 11 | | 100 V | megaohms |
| (inventive) | | | |
| with 22 wt % | greater than | greater than | greater than 3 |
| filler 1 | 3 gigaohms | 5000 V | gigaohms |
| (comparative 1) | | | |
| with 22 wt % | 100-800 megaohms | less than | less than 100 |
| filler 1 and | | 100 V | megaohms |
| 2.5 wt % | | | |
| Basionics | | | |
| VS03/FS01 | | | |
| (comparative 2) | | | |

1. A method for making a coating or sealing composition comprising:
incorporating organic filler(s) comprising at least 20 wt % of at least one organic polymer and at least one ionic liquid into a coating or sealing composition.

2. The method according to claim1, wherein the organic polymer comprises polyamide or polyurethane.

3. The method according to claim 1, wherein the cation of the ionic liquid comprises a quaternary ammonium cation or a cation having a heterocyclic ring system with delocalized positive charge or with a localized positive charge on one of the ring atoms.

4. The method according to claim 1, wherein the ionic liquid is an imidazolium salt of formula I: 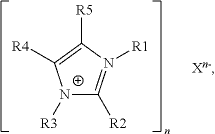
in which
R1 is an organic radical having 1 to 20 C atoms,
R2, R4, R3, and R5 are each an H atom or an organic radical having 1 to 20 C atoms,
X is an anion, and
n is 1, 2, or 3.

5. The method according to claim 1, wherein the anion of the ionic liquid is thiocyanate or dicyandiamide.

6. The method according to claim 1, wherein the fillers comprise 1 to 20 wt % of ionic liquid, based on the total weight of the fillers.

7. The method according to claim 1, wherein the fillers comprise powders.

8. The method according to claim 1, wherein the fillers comprise a powder having a particle size distribution with a d₅₀ of 5 to 500 μm.

9. The method according to claim 1, wherein the filler is obtained by milling the polymer to a powder and subsequently treating the powder with ionic liquid.

10. A coating or sealing composition comprising organic fillers according to claim 1.

11. A coating or sealing composition comprising at least 0.1 wt % of the organic fillers according to claim 1, based on the total weight of all constituents of the coating composition except for water and organic solvents.

12. The coating composition according to claim 10, being an adhesive, paint, varnish, paper-coating composition, or floor-coating composition.

13. An article coated with a coating composition according to claim 10.

14. A floor-coating composition comprising 5 to 40 wt % of the organic fillers according to claim 1, based on the total weight of all constituents of the floor₌coating composition except for water and organic solvents.

15. A floor coating obtainable with a floor₌coating composition according to claim 14.

16. The floor coating according to claim 15, with coat thicknesses from 1 mm to 30 mm.
